(19) United States
(12) Patent Application Publication
(10) Pub. No.: US 2022/0095796 A1
(43) Pub. Date: Mar. 31, 2022

(54) Calcium Aluminate Cement Bonded Ceramic Matrix For Use As Heat Resistant Countertops and Similar Components in the Building and Construction Industry

(71) Applicant: Westmoreland Advanced Materials, Inc., Charleroi, PA (US)

(72) Inventors: Kenneth A. McGowan, Harrison City, PA (US); Robert M. Cullen, Bethel Park, PA (US)

(21) Appl. No.: 17/449,047

(22) Filed: Sep. 27, 2021

Related U.S. Application Data
(60) Provisional application No. 63/198,081, filed on Sep. 28, 2020.

(51) Int. Cl. A47B 96/18; C04B 7/32

(52) U.S. Cl. CPC A47B 96/18; A47B 2200/001; C04B 7/32

(57) ABSTRACT

A heat resistant countertop or a heat resistant three dimensional shape product comprising a composition comprising at least one aggregate, at least one cement, at least one fine material, at least one dispersant, and at least one viscosity modifier, and optionally at least one set retarder, and optionally at least one set accelerator. A heat resistant countertop or a heat resistant three dimensional shape product comprising a calcium aluminate cement hydraulic binder and matrix is provided.

### CROSS REFERENCE TO RELATED APPLICATION

This utility non-provisional patent application claims the benefit of priority to pending U.S. Provisional Patent Application Ser. No. 63/198,081, filed Sep. 28, 2020. The entire contents of U.S. Provisional Patent Application Ser. No. 63/198,081 is incorporated by references into this utility non-provisional patent application as if fully rewritten herein.

### BACKGROUND OF THE INVENTION

### 1. Field of Use

The use of Calcium Aluminate bonded ceramic materials will provide heat resistant countertop and similar building and construction components for use as building components replacing traditional materials such as laminates, polymer-based compositions, polymer bonded mineral systems and cast Calcium Silicate systems in the building and construction trades.

The present invention provides a flame and/or heat resistant countertop or similar product that to be used in the building and construction trades. The invention provides a hard, abrasion resistant work top that will resist high temperatures so that hot cooking implements, and similar items can be placed directly on the surface without concern for damage or ignition. The present invention can be cast or molded into almost any three-dimensional structure to fit the end user's construction and practical use needs.

Furthermore, Calcium Aluminate cements are available in a variety of formulations. Several of these result in a pure or almost pure white material. This provides the capability of producing pure or almost pure white products and/or products that have a pure or almost pure white matrix. This is an important design capability not available for Calcium Silicate cements which are almost always grey in color. There are also Calcium Aluminate cements that are grey, brown and a variety of similar shades and colors but still provide for high temperature resistance.

### 2. Background of Invention

Calcium aluminate cements are a type of hydraulic cement that is primarily used to make refractory compositions and other industrial components used in various high temperature processes, such as steel and aluminum manufacturing.

Unlike Calcium Silicate cement compositions, that are primarily used in the construction industry, Calcium Aluminate cements have a much high melting point and are less susceptible to explosive dehydration upon exposure to heat. This makes Calcium Aluminate cement the preferred hydraulic bonding system for manufacturing high temperature products such as refractories.

Calcium Silicate cements are typically much less expensive than Calcium Aluminate cements and develop similar, and under some conditions, better strength characteristics at lower temperatures. Thus, Calcium Silicate cements are the preferred hydraulic systems for the construction and building industry.

Those skilled in the art, such as ceramic engineers, have developed compositional strategies that allow a variety of placement options for Calcium Aluminate bonded compositions. Some of these installation techniques are gunning, vibration casting, shotcreting, and ramming to name a few. Most of these have no application in the building and construction trades not associated with refractories. However, a few compositional strategies that result in vibration cast and more preferably self-flowing compositions have significant impact for the proposed invention.

Because of the lack of highly heat resistant materials for use as countertops, et. al. The use of Calcium Aluminate as a binder for ceramic aggregates to create such a countertop, et. al. fills a need for both domestic and commercial application. The invention provides a non-combustible component that can be directly exposed to heat and flame and therefore provides a much safer building component.

Those skilled in the art will also recognized the importance of being able to utilize a binder or matrix that is pure or almost pure white. This provides a background that will allow the creation of highly desirable patterns and visual designs attractive and/or desired by the end user. This binder combined with several available synthetic or naturally occurring minerals and compounds provides a dynamic and creative pallet of color and contrast a skilled designer will use to create unique products. Those who prefer a darker background can utilize nonwhite calcium aluminate binders while still retaining the non-combustible attribute and resistance to open flame and high heat.

### SUMMARY OF THE INVENTION

The present invention provides a composition comprising a calcium aluminate cement in one or more forms as a binder for ceramic aggregates and additives resulting in a castable composition that can be used to form a heat resistant three dimensional structure (product shape), preferably for use as a countertop or similar item within the building and construction trades.

The composition is engineered to allow installation by one of several methods of casting such as vibration casting and more preferably casting via a self-flowing and self-leveling process. The composition can be installed in place or it can be premanufactured at one location and installed in another. If the product is installed in place it can be installed without any joints which is aesthetically desirable. This is also a possibility if the product is precast and of smaller size.

The composition is engineered to allow inclusion of a variety of natural or synthetic ceramic aggregate to provide desirable visual qualities to the final product without affecting physical performance. Examples of some of these are tabular alumina, silicon carbide, andalusite, mullite, clays, sillimanite, fused silica, fused white and fused brown alumina, Magnesite, Broken or crushed glasses, and other decorative minerals or compounds of which there are many.

Once the present invention is set or hardened it can be polished to a smooth and attractive surface utilizing techniques and tools know to those persons skilled in the art.

If desired, the composition can be optionally treated with several commercially available surface treatment product that provide for improved penetration resistance to many liquids, particularly water-based liquids.

In one embodiment of this invention a heat resistant countertop or a heat resistant three dimensional shape product is provided comprising a composition comprising at least one aggregate, at least one cement, at least one fine material, at least one dispersant, and at least one viscosity modifier, and optionally at least one set retarder, and optionally at least one set accelerator. The aggregate is at least one selected from the group consisting of a tabular alumina, a fused white alumina, a silicon carbide, an andalusite, a fire clay, a mullite, a recycled glass, and a natural stone. The natural stone is a marble, a granite, a shale, or a river rock. The cement is at least one selected from the group of a 40% to 80% alumina containing calcium aluminate cement. The fine material (i.e. “fines”) is at least one selected from the group consisting of a calcined alumina, a reactive alumina, a clay, a kyanite, a micro silica, and a silica sand. The dispersant is at least one selected from the group consisting of a sodium phosphate, a poly acrylate, a sulfonate, a polyethyelene glycol, and a polycarboxylate ether. The sulfonate is either a lingo sulfonate, a naphthalene sulfonate, or a melamine sulfonate. The viscosity modifier is at least one selected form the group of a cellulose, a gum, and a clay. The set retarder is at least one selected from the group consisting of a citric acid, a boric acid, an acetic acid, a gluconic acid, and a tartaric acid. The set accelerator is at least one selected from the group consisting of an alkali salt, a hydroxide, and a calcium containing compound. The heat resistant countertop or heat resistant three dimensional shape product is flame resistant and heat resistant to temperatures greater than about 100 degrees Centigrade to about 482 degrees Centigrade, or greater.

### DETAILED DESCRIPTION OF THE INVENTION

The present invention provides a calcium aluminate hydraulically bonded ceramic matrix or composition that provides for a non-combustible, flame and heat resistant three-dimensional structure suitable for use as a countertop or similar component used in the construction and building trades.

The preferred embodiment of the invention provides for a castable composition, more preferably a self-flowing and/or self-leveling composition that can be cast into a mold, either on site or at a manufacturing facility. To accomplish this, mix technology known to those persons of ordinary skill in the art would necessarily include one or more of a dispersant, a set retarder, a set accelerator and a viscosity modifying agent.

The invention can be cast to form precast shapes that can be moved to an installation site or more preferably, cast in a single monolithic pour so as to eliminate any joints or seams in the final product. This is especially desirable if the final product is too large or cumbersome to be transported easily.

The product can be comprised entirely from calcium aluminate cement. However, a preferred embodiment includes one or more decorative synthetic or naturally occurring minerals or compounds. These can be of various sizes or they may be uniform in size to provide the aesthetics desired by the end user. These can be of various colors or they may have uniform color pallet to provide the aesthetics desired by the end user. Whatever is chosen the melting points must be suitable to avoid phase changes when exposed to typical commercial or residential kitchen temperatures. The highest would be a temperature resulting from contact with and open flame or electric heating element. Thus, for example, but not limited to, melting point temperatures must be greater than about 100 degrees Centigrade (i.e. a temperature about 212 degrees Fahrenheit) and up to about 482 degrees Centigrade (i.e. about 900 degrees Fahrenheit), or greater.

The cast and set product may be used directly without further treatment. However, the preferred embodiment is a product that is polished to provide a smooth and attractive working surface. The surface of the product may be optionally treated with one of several commercially available sealers to provide to additional resistance to liquids and hence staining.

As used herein, mesh sizes have the following meaning. A minus (−) mesh size represents a particle diameter size that is smaller or equal to the mesh size numbered indicated. A positive (+) mesh size means a particle diameter size that is greater than or equal to the mesh size number indicated. Thus for example, but not limited to, a “−325 mesh” means a particle having a diameter that is smaller in size that is equal to or smaller than 325 mesh. Thus, for example, but limited to, a “+200 mesh” means a particle having a diameter that is equal to or larger than 200 mesh. Thus, for example, but not limited to, a Tyler mesh size of “−3 +8” means at least one particle having a diameter that is equal to or smaller than 3 mesh and at least one particle having a diameter that is from equal to or greater than 8 mesh.

In one embodiment of this invention a heat resistant countertop or a heat resistant three dimensional shape product is provided comprising a composition comprising at least one aggregate, at least one cement, at least one fine material, at least one dispersant, and at least one viscosity modifier, and optionally at least one set retarder, and optionally at least one set accelerator. The aggregate is at least one selected from the group consisting of a tabular alumina, a fused white alumina, a silicon carbide, an andalusite, a fire clay, a mullite, a recycled glass, and a natural stone. The natural stone is a marble, a granite, a shale, or a river rock. The cement is at least one selected from the group of a 40% to 80% alumina containing calcium aluminate cement. The fine material (i.e. “fines”) is at least one selected from the group consisting of a calcined alumina, a reactive alumina, a clay, a kyanite, a micro silica, and a silica sand. The dispersant is at least one selected from the group consisting of a sodium phosphate, a poly acrylate, a sulfonate, a polyethyelene glycol, and a polycarboxylate ether. The sulfonate is either a lingo sulfonate, a naphthalene sulfonate, or a melamine sulfonate. The viscosity modifier is at least one selected form the group of a cellulose, a gum, and a clay. The set retarder is at least one selected from the group consisting of a citric acid, a boric acid, an acetic acid, a gluconic acid, and a tartaric acid. The set accelerator is at least one selected from the group consisting of an alkali salt, a hydroxide, and a calcium containing compound. The heat resistant countertop or heat resistant three dimensional shape product is flame resistant and heat resistant to temperatures greater than about 100 degrees Centigrade to about 482 degrees Centigrade, or greater. Preferably, the heat resistant countertop or heat resistant three dimensional shape product of this invention is a castable. It will be appreciated that the at least one aggregate, the at least one cement, and the at least one fine material may have various ranges of mesh sizes for achieving particle packing.

In another embodiment of this invention, the heat resistant countertop or heat resistant three dimensional shape product, as described herein, is a self-flowing or self-leveling composition when placed into a mold.

In another embodiment of this invention, the heat resistant countertop or heat resistant three dimensional shape product, as described herein, is a pre-cast shape.

In yet another embodiment of this invention, the heat resistant countertop or heat resistant three dimensional shape product, as described herein, optionally includes at least one decorative material.

In another embodiment of this invention, the heat resistant countertop or heat resistant three dimensional shape product, as described herein, has a surface that is optionally treated or coated with a sealants or a wetting angle modifier. The sealant or the wetting angle modifier is a silane repellant or a siloxane repellent to inhibit penetration of the surface by a liquid and resist staining of the surface.

In another embodiment of this invention, the heat resistant countertop or heat resistant three dimensional shape product, as described herein, has a surface that is set and cured. The set and cured surface may be optionally polished.

Another embodiment of this invention provides a heat resistant countertop or a heat resistant three dimensional shape product comprising a calcium aluminate cement hydraulic binder and matrix.

### DETAILED COMPOSITIONAL/DESIGN STRATEGIES

In example 1, a lower percentage alumina containing calcium aluminate cement is used as the binder and as the surrounding aggregate matrix. These cements can be while in color but are often grey or brown depending on the raw materials utilized and the processing environment. These cements are typically referred to as 40% or 60% Alumina containing, Calcium aluminate cements. In this case, the aggregates chosen for this example is a variety of Mullite bearing grain sizes. These will provide a pattern or design incorporating components larger than that of the grain size of the cement bonding matrix. When polished this inclusion is highlighted as trapped multicolor decorative components. They are also highly heat and flame resistant. Dispersants are added to allow the combined materials to flow under their own weight or with vibration, thereby uniformly filling up a mold. A viscosity modifier is added to avoid a process called ‘bleeding out’ where water accumulates on the surface of the cast material, causing cracking. It also avoids excess water from leaking out of the mold. In these examples we are also incorporating a set retarder and a set accelerator. The combination of these two additives ‘buffers’ the setting of the composition allowing it to set in an expected and uniform time frame. This is typically designed to be between 14 and 24 hours.

The following list contains possible components of the compositions described. These are intended as examples and do not represent an exhaustive list since actual design is an artistic endeavor. The only requirement is that the components chosen result in a flame and heat resistant end product that can be cast in place as a monolith if desired. It must harden or set and then be able to be polished or otherwise prepared to the tastes of the end user(s).

Aggregates: Tabular alumina, Fused white alumina, Silicon Carbide, Andalusite, Fire Clay, Mullite, Recycled Glass, Natural Stones (marble, granite, shale, river rock, etc.)

Fines (or fine material): Calcined Aluminas, Reactive Aluminas, Clays, Kyanites, Micro Silicas (white, grey, black), Silica sands.

Cements: 40% to 80% alumina containing Calcium aluminate cements such as Imerys/Kerneos' Secar 41, Secar 51, Secar 71, and Secar 80. Gorka's Gorkal 40, Gorkal 50 and Gorkal 70. Almatis' CA-14, CA-25. Calucme's Istra 40 and Istra 50, Lumnite, Refcon. HiPerCem products.

Dispersants: Sodium Phosphates, Poly acrylates, sulfonates (ligno, Napthalene, Melamine), Polyethyelene Glycols, Polycarboxylate Ethers.

Set Accelerators: Alkali Salts, Hydroxides, soluble Calcium containing compounds.

Set Retarders: Citric, Boric, Acetic, Gluconic and Tartaric acids.

Vicosity Modifying Agents (viscosity modifier): Celluloses, Gums, Clays. Details of the components listed in the following examples are listed here:

The Mulcoa 47 and/or 60 and/or 70 materials and the Ball Clay used in Example 1, and the Andalusite used in Example 2 are from Imerys Refractory Minerals, 43, quai de Grenelle, 75015 Paris, France. The Calcium Missouri Fire Clay used in Example 3 is from Christy Minerals, P.O. Box 159, High Hill, Mo. 63350, USA. The Fused White Alumina and Silicon Carbide used in Examples 4 and 5 are from U.S. Electrofused Minerals, Inc., 600 Steel Street, Aliquippa, Pa. 15001, USA. The Tabular Alumina used in Example 6, along with the Calcined and Reactive Aluminas used in the examples, are from Almatis GmbH, Lyoner Str. 9, 60528 Frankfurt, Germany. The 40% to 60% Alumina, Calcium Aluminate Cements used in Example 1 are from Calucem, 7540 Windsor Drive, Suite 304, Allentown, Pa. 18195, USA. The 70% to 80% Alumina, Calcium Aluminate Cements used in the other examples are from Imerys Aluminates: Immeuble Pacific, 11, cours Valmy, Paris—La Défense 92800 Puteaux, France. The Raw Kyanites used in the examples are from Kyanite Mining Corporation, 30 Willis Mt Plant Road, Dillwyn, Va. 23936, USA. The Micro Silica used in the examples is from Elkem Silicon Materials, Airport Office Park, Building 2, 400 Rouser Road, Moon Township, Pa. 15108-2749 USA. The Dispersant, Castament FS 20, used in the examples is from BASF Construction Chemicals, 95 Pineview Drive, Amherst, N.Y. 14228-2166, USA. The Set Accelerator, Lithium Carbonate; The Set Retarder, Citric Acid; and the Viscosity Modifying Agent, Methocel K4M; are from Chempoint, A Univar Solutions Company, 3075 Highland Pkwy, Ste. 200, Downers Grove, Ill. 60515, USA.

It will be appreciated that aggregate(s), the cement(s), and the fine material(s) (i.e. “fines”) may have various ranges of mesh sizes for achieving particle packing. The mesh sizes in the examples that follow are illustrative and are not meant to limit the breadth of the invention described herein.

### Example 1

| Mix Details: | Size Fraction | Percentage |
|---|---|---|
| Raw Material: | (Tyler): | (Wt. basis) |
| Mulcoa 47 and/or 60 and/or 70 | −3 + 8 mesh | 35 |
| (commercial names of mullite | | |
| bearing aggregated | | |
| Mulcoa 47 and/or 60 and/or 70 | −8 + 20 mesh | 13 |
| Mulcoa 47 and/or 60 and/or 70 | −20 mesh | 16 |
| Mulcoa 47 and/or 60 and/or 70 | −200 mesh | 8 |
| Raw Kyanite (mineral name) | −325 mesh | 6 |
| Micro Silica (type of very fine silica) | D₅₀ = 0.5 micron | 5 |
| 40% to 60% Alumina Calcium | −325 mesh | 15 |
| Aluminate Cement | | |
| Ball Clay (a specific type of | −325 mesh | 2 |
| clay mineral) | | |
| Plus Additions: | | Percentage |
| Function: | Raw Material: | (Wt. basis) |
| Dispersant | Castament FS20 | 0.5 |
| Set Accelerator | Lithium Carbonate | 0.01 |
| Set Retarder | Citric Acid | 0.02 |
| Viscosity Modifying Agent | Methocel K4M | 0.02 |

### Example 2

| Mix Details: | Size Fraction | Percentage |
|---|---|---|
| Raw Material: | (Tyler): | (Wt. basis) |
| Andalusite | −3 + 8 mesh | 35 |
| Andalusite | −8 + 20 mesh | 13 |
| Andalusite | −20 mesh | 12 |
| Raw Kyanite | −200 mesh | 8 |
| Raw Kyanite | −325 mesh | 8 |
| Calcined Alumina | D₅₀ = 6.5 microns | 8 |
| Micro Silica | D₅₀ = 0.5 micron | 8 |
| 70% to 80% Alumina Calcium | −325 mesh | 8 |
| Aluminate Cement | | |
| Plus Additions: | | Percentage |
| Function: | Raw Material: | (Wt. basis) |
| Dispersant | Castament FS20 | 0.5 |
| Set Accelerator | Lithium Carbonate | 0.01 |
| Set Retarder | Citric Acid | 0.02 |
| Viscosity Modifying Agent | Methocel K4M | 0.02 |

### Example 3

| Mix Details: | Size Fraction | Percentage |
|---|---|---|
| Raw Material: | (Tyler): | (Wt. basis) |
| Calcined Missouri Fire Clay | −3 + 8 mesh | 35 |
| Calcined Missouri Fire Clay | −8 + 20 mesh | 13 |
| Calcined Missouri Fire Clay | −20 mesh | 16 |
| Calcined Missouri Fire Clay | −200 mesh | 8 |
| Raw Kyanite | −200 mesh | 10 |
| Calcined Alumina | D₅₀ = 6.5 microns | 10 |
| Micro Silica | D₅₀ = 0.5 micron | 5 |
| 70% to 80% Alumina Calcium | −325 mesh | 5 |
| Aluminate Cement | | |
| Plus Additions: | | Percentage |
| Function: | Raw Material: | (Wt. basis) |
| Dispersant | Castament FS20 | 0.5 |
| Set Accelerator | Lithium Carbonate | 0.01 |
| Set Retarder | Citric Acid | 0.02 |
| Viscosity Modifying Aeent | Methocel K4M | 0.02 |

### Example 4

| Mix Details: | Size Fraction | Percentage |
|---|---|---|
| Raw Material: | I(Tyler): | (Wt. basis) |
| Fused White Alumina | −4 + 10 mesh | 25 |
| Fused White Alumina | −10 + 20 mesh | 15 |
| Fused White Alumina | −20 + 40 mesh | 8 |
| Fused White Alumina | −40 + 200 mesh | 7 |
| Fused White Alumina | −200 mesh | 10 |
| Calcined Alumina | D₅₀ = 6.5 microns | 10 |
| Reactive Alumina | D₅₀ = 2.5 microns | 10 |
| Reactive Alumina | D₅₀ = 0.5 micron | 5 |
| Micro Silica | D₅₀ = 0.5 micron | 5 |
| 70% to 80% Alumina Calcium | −325 mesh | 5 |
| Aluminate Cement | | |
| Plus Additions: | | Percentage |
| Function: | Raw Material: | (Wt. basis) |
| Dispersant | Castament FS20 | 0.5 |
| Set Accelerator | Lithium Carbonate | 0.01 |
| Set Retarder | Citric Acid | 0.02 |
| Viscosity Modifying Agent | Methocel K4M | 0.02 |

### Example 5

| Mix Details: | Size Fraction | Percentage |
|---|---|---|
| Raw Material: | I(Tyler): | (Wt. basis) |
| Silicon Carbide | −4 + 8 mesh | 25 |
| Silicon Carbide | −8 + 16 mesh | 15 |
| Silicon Carbide | −16 + 35mesh | 8 |
| Silicon Carbide | −35 + 70 mesh | 7 |
| Silicon Carbide | −70 mesh | 10 |
| Silicon Carbide | −200 mesh | 5 |
| Calcined Alumina | D₅₀ = 6.5 microns | 5 |
| Reactive Alumina | D₅₀ = 2.5 microns | 10 |
| Reactive Alumina | D₅₀ = 0.5 micron | 5 |
| Micro Silica | D₅₀ = 0.5 micron | 5 |
| 70% to 80% Alumina Calcium | −325 mesh | 5 |
| Aluminate Cement | | |
| Plus Additions: | | Percentage |
| Function: | Raw Material: | (Wt. basis) |
| Dispersant | Castament FS20 | 0.5 |
| Set Accelerator | Lithium Carbonate | 0.01 |
| Set Retarder | Citric Acid | 0.02 |
| Viscosity Modifying Agent | Methocel K4M | 0.02 |

### Example 6

| Mix Details: | Size Fraction | Percentage |
|---|---|---|
| Raw Material: | I(Tyler): | (Wt. basis) |
| Tabular Alumina | −3 + 6 mesh | 15 |
| Tabular Alumina | −6 + 14 mesh | 25 |
| Tabular Alumina | −14 + 28 mesh | 8 |
| Tabular Alumina | −28 + 48 mesh | 7 |
| Tabular Alumina | −48 mesh | 10 |
| Calcined Alumina | D₅₀ = 6.5 microns | 10 |
| Reactive Alumina | D₅₀ = 2.5 microns | 10 |
| Reactive Alumina | D₅₀ = 0.5 micron | 5 |
| Micro Silica | D₅₀ = 0.5 micron | 5 |
| 70% to 80% Alumina Calcium | −325 mesh | 5 |
| Aluminate Cement | | |
| Plus Additions: | | Percentage |
| Function: | Raw Material: | (Wt. basis) |
| Dispersant | Castament FS20 | 0.5 |
| Set Accelerator | Lithium | 0.01 |
| | Carbonate | |
| Set Retarder | Citric Acid | 0.02 |
| Viscosity Modifying Agent | Methocel K4M | 0.02 |

### Example 7

| Mix Details: | Size Fraction | Percentage |
|---|---|---|
| Raw Material: | (Tyler): | (Wt. basis) |
| Mulcoa 47 (commercial name of | −8 + 20 mesh | 10 |
| Fireclay/Mullite bearing aggregate) | | |
| Mulcoa 47 | −20 mesh | 10 |
| Mulcoa 47 | −200 mesh | 15 |
| Calcined Chinese Bauxite | −⅜ inch + 4 mesh | 15 |
| TECO-SIL Fused Silica | −4 + 10 mesh | 20 |
| A-2 Calcined Alumina | −325 mesh | 15 |
| 70% Alumina Calcium | −325 mesh | 10 |
| Aluminate Cement | | |
| PSF 94U White Micro Silica, | D₅₀ = 0.5 micron | 5 |
| Panadyne | | |
| Plus Additions: | | Percentage |
| Function: | Raw Material: | (Wt. basis) |
| Dispersant | Castament FS20 | 0.05 |
| Set Accelerator | Calcium Sulfate | 0.2 |
| Water to Cast | | 8.5 |

In Example 7, the Mulcoa 47, Teco-Sil Fused Silica and the Secar 71 Cement are from Imerys Refractory Minerals, 43, quai de Grenelle, 75015 Paris, France; the A-2 Calcined Alumina is from Almatis GmbH, Lyoner Str. 9, 60528 Frankfurt, Germany; the Calcined Chinese Bauxite is from Great Lakes Minerals, LLC, 1200 Port Road, Wurtland, Ky. 41144 USA; the PSF 94U White Micro Silica is from Panadyne, 516 Stump Rd, Montgomeryville, Pa. 18936, USA; the Castament FS 20 is from BASF Construction Chemicals, 95 Pineview Drive, Amherst, N.Y. 14228-2166, USA, and the Calcium Sulfate is #1 Pottery Plaster from US Gypsum, 550 West Adams Street, Ill. 60661, USA.

In all examples, once the material is set, and optionally polished, the resulting surfaces are optionally treated by painting on a coating of a silane/siloxane repellent.

These examples are not intended to limit the scope of the present invention as described herein. These examples are for purposes of illustration and it will be evident to those persons skilled in the art that numerous variations and details of the instant invention may be made without departing from the instant invention as set forth herein and as defined in the appended claims.

What is claimed is:

1. A heat resistant countertop or a heat resistant three dimensional shape product comprising a composition comprising at least one aggregate, at least one cement, at least one fine material, at least one dispersant, and at least one viscosity modifier, and optionally at least one set retarder, and optionally at least one set accelerator.

2. The heat resistant countertop or heat resistant three dimensional shape product of claim 1 wherein said aggregate is at least one selected from the group consisting of a tabular alumina, a fused white alumina, a silicon carbide, an andalusite, a fire clay, a mullite, a recycled glass, and a natural stone.

3. The heat resistant countertop or heat resistant three dimensional shape product of claim 2 wherein said natural stone is a marble, a granite, a shale, or a river rock.

4. The heat resistant countertop or heat resistant three dimensional shape product of claim 1 wherein said cement is at least one selected from the group of a 40% to 80% alumina containing calcium aluminate cement.

5. The heat resistant countertop or heat resistant three dimensional shape product of claim 1 wherein said fine material is at least one selected from the group consisting of a calcined alumina, a reactive alumina, a clay, a kyanite, a micro silica, and a silica sand.

6. The heat resistant countertop or heat resistant three dimensional shape product of claim 1 wherein said dispersant is at least one selected from the group consisting of a sodium phosphate, a poly acrylate, a sulfonate, a polyethyelene glycol, and a polycarboxylate ether.

7. The heat resistant countertop or heat resistant three dimensional shape product of claim 6 wherein said sulfonate is either a lingo sulfonate, a naphthalene sulfonate, or a melamine sulfonate.

8. The heat resistant countertop or heat resistant three dimensional shape product of claim 1 wherein said viscosity modifier is at least one selected form the group of a cellulose, a gum, and a clay.

9. The heat resistant countertop or heat resistant three dimensional shape product of claim 1 wherein said set retarder is at least one selected from the group consisting of a citric acid, a boric acid, an acetic acid, a gluconic acid, and a tartaric acid.

10. The heat resistant countertop or heat resistant three dimensional shape product of claim 1 wherein said set accelerator is at least one selected from the group consisting of an alkali salt, a hydroxide, and a calcium containing compound.

11. The heat resistant countertop or heat resistant three dimensional shape product of claim 1 that is flame resistant and heat resistant to temperatures greater than about 100 degrees Centigrade to about 482 degrees Centigrade.

12. The heat resistant countertop or heat resistant three dimensional shape product of claim 1 that is a castable.

13. The heat resistant countertop or heat resistant three dimensional shape product of claim 1 that is a self-flowing or self-leveling composition when placed into a mold.

14. The heat resistant countertop or heat resistant three dimensional shape product of claim 1 that is a pre-cast shape.

15. The heat resistant countertop or heat resistant three dimensional shape product of claim 1 including a decorative material.

16. The heat resistant countertop or heat resistant three dimensional shape product of claim 1 having a surface that is optionally treated or coated with a sealants or a wetting angle modifier.

17. The heat resistant countertop or heat resistant three dimensional shape product of claim 16 wherein said sealant or said wetting angle modifier is a silane repellant or a siloxane repellent to inhibit penetration said surface by a liquid and resist staining of said surface.

18. The heat resistant countertop or heat resistant three dimensional shape product of claim 1 that has a surface that is set and cured.

19. The heat resistant countertop or heat resistant three dimensional shape product of claim 18 wherein said surface that is set and cured is polished.

20. A heat resistant countertop or a heat resistant three dimensional shape product comprising a calcium aluminate cement hydraulic binder and matrix.
